(19) United States
(12) Patent Application Publication
(10) Pub. No.: US 2016/0013654 A1
(43) Pub. Date: Jan. 14, 2016

(54) DYNAMIC POWER SUPPLY SELECTION BASED ON SYSTEM REQUIREMENTS

(71) Applicant: QUALCOMM Incorporated, San Diego, CA (US)

(72) Inventor: Juhi Saha, San Mateo, CA (US)

(21) Appl. No.: 14/327,088

(22) Filed: Jul. 9, 2014

(51) Int. Cl. H02J 4/00

(52) U.S. Cl. CPC H02J 4/00

(57) ABSTRACT

Selecting power supplies for loads, including: determining a new load requirement for the loads when a load change event, which identifies a need to change power supply-to-load connections, is detected; selecting at least one power supply for at least one load based on the new load requirement to generate new power supply-to-load connections; and transitioning to the new power supply-to-load connections.

### BACKGROUND

1. Field

This invention relates to power supplies, and more specifically, to dynamically selecting power supplies-to-load connections based on requirements and capabilities.

2. Background

Multiple loads are often powered by the same regulator or power supply. This can lead to unnecessary power being consumed by a system, as rails that could function at a lower voltage are forced to operate at the maximum requested voltage of all rails sharing the same power supply. In other cases, different load or power supply requirements arise that necessitate changes in system requirements. For example, FIG. 1 is a functional block diagram of a conventional power rail system showing a power management integrated circuit (PMIC) 110 and a system-on-chip (SoC) 170. In FIG. 1, the PMIC 110 includes a plurality of power supplies (PS1, PS2, . . . , PSn) 120, 122, 126 configured to supply power to the SoC 170 including loads 140, 142, 144, 146, 148, 150 which are connected to a plurality of power rails 130, 132, 134. However, the loads 140-150 are hard-wired to the power rails 130, 132, 134, which are hard-wired to the power supplies 120, 122, 126. Thus, in this configuration, a load is forced to use the maximum of the power requirements of loads sharing a power rail. For example, since load 1 (140) is connected to the same rail as load 2 (142) and load 3 (144), load 1 is forced to share the maximum voltage required by any one of the other loads 2 and 3, which may be higher than the voltage required to run load 1 (140). This means that power is wasted since load 1 is operating at a higher voltage than is needed.

### SUMMARY

The present invention provides for enabling dynamic power supply selection by loads based on their requirements and capabilities.

In one embodiment, a method of selecting power supplies for loads is disclosed. The method includes: determining a new load requirement for the loads when a load change event, which identifies a need to change power supply-to-load connections, is detected; selecting at least one power supply for at least one load based on the new load requirement to generate new power supply-to-load connections; and transitioning to the new power supply-to-load connections.

In another embodiment, a dynamic power supply selection system is disclosed. The system includes: a plurality of power rails configured to connect at least one power supply to at least one load; and a power rail controller configured to determine a load requirement for the at least one load when a load change event is detected, wherein the load change event identifies a need to change power supply-to-load connections, the power rail controller also configured to select the at least one power supply for the at least one load based on the new load requirement and to transition the plurality of power rails to the selected power supply-to-load connections.

In another embodiment, an apparatus for selecting power supplies for loads is disclosed. The apparatus includes: means for determining a new load requirement for the loads when a load change event, which identifies a need to change power supply-to-load connections, is detected; means for selecting at least one power supply for at least one load based on the new load requirement to generate new power supply-to-load connections; and means for transitioning to the new power supply-to-load connections.

In yet another embodiment, a non-transitory storage medium storing a computer program to select power supplies for loads is disclosed. The computer program includes executable instructions that cause a computer to: determine a new load requirement for the loads when a load change event, which identifies a need to change power supply-to-load connections, is detected; select at least one power supply for at least one load based on the new load requirement to generate new power supply-to-load connections; and transition to the new power supply-to-load connections.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1 is a functional block diagram of a conventional power rail system showing a power management integrated circuit (PMIC) and a system-on-chip (SoC);

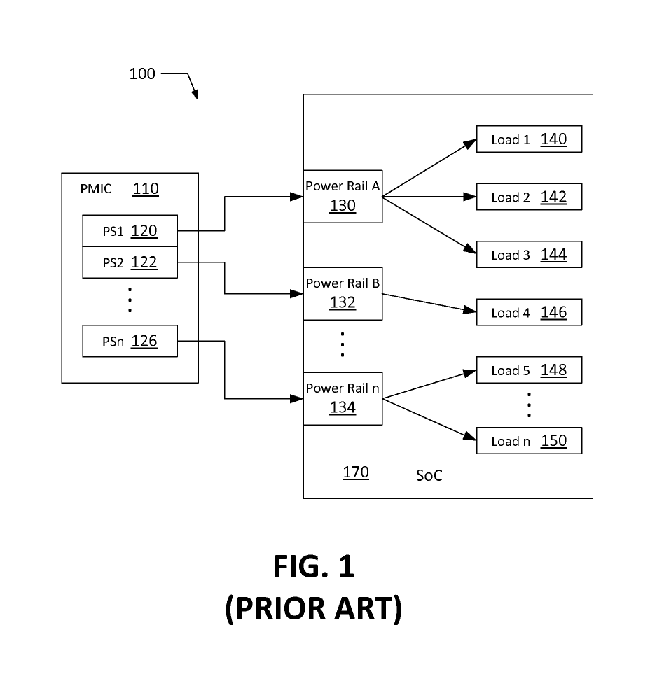

FIG. 2 is a functional block diagram illustrating a dynamic power supply selection system in accordance with one embodiment of the present invention;

FIG. 3 is a schematic diagram of one of the power rails in accordance with one embodiment of the present invention;

FIG. 4 is a summary of the lookup tables in accordance with one embodiment of the present invention; and

FIG. 5 is a flow diagram illustrating a method for dynamically selecting power supplies for each load in accordance with one embodiment of the present invention.

### DETAILED DESCRIPTION

As stated above, powering multiple loads with the same power supply often leads to unnecessary power being consumed by a system. This may require changes in the power supply to load connections to optimize the power consumption. However, in some cases, the load changes (e.g., an increase in current draw, switching frequency requirements, etc.) may be necessitated because the loads have requirements that are not being met by the connected power supplies. In these cases, changes are made to optimize the system performance or satisfy the system requirements.

Several embodiments as described herein provide for enabling dynamic power supply selection by loads based on their requirements and capabilities. The dynamic selection of the power supply/supplies for loads also includes merging or splitting of the power rails to provide different power supply-to-load connections. Power supplies are merged to meet increased load requirements if necessary, and are split to change the voltage requirements or to reduce the power load requirements. The power supply selection also includes adding a power rail controller to dynamically select and match power supplies to loads based on the requirements and capabilities of the power supplies and the loads. The selection is made to provide a configuration in which power consumption is minimized, battery life is maximized, and/or the load requirements are met. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

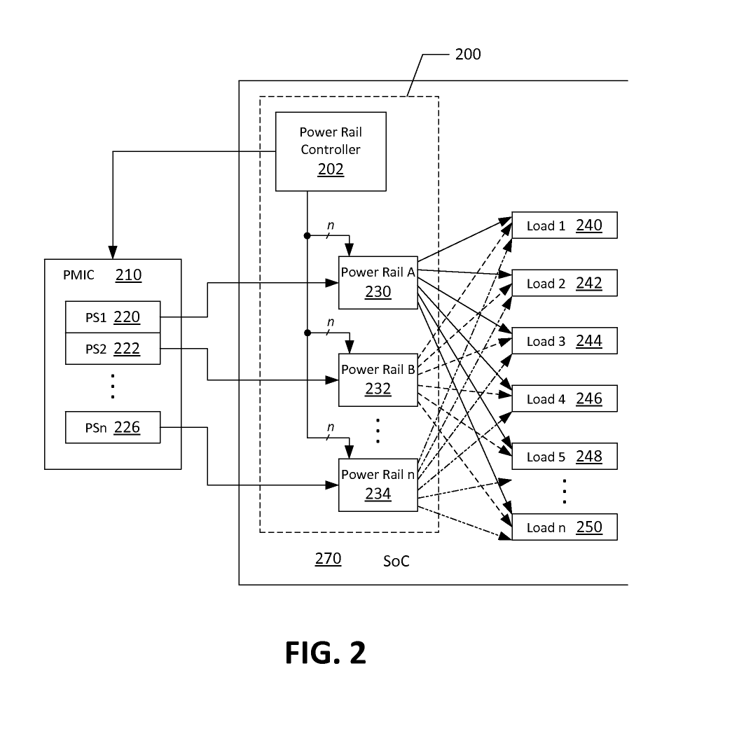

FIG. 2 is a functional block diagram illustrating a dynamic power supply selection system 200 in accordance with one embodiment of the present invention. In FIG. 2, the dynamic power supply selection system 200 resides within the SoC 270. However, in other embodiments, the dynamic power supply selection system 200 resides outside of the SoC 270 or within a power management integrated circuit (PMIC) 210. The dynamic power supply selection system 200 comprises a power rail controller 202 and a plurality of power rails (i.e., power rail A 230, power rail B 232, . . . , power rail n 234). In the illustrated embodiment of FIG. 2, the power rail controller 202 operates in conjunction with the PMIC 210 to determine which power supply connects to which load based on the requirements and capabilities of the power supplies (i.e., PS1 220, PS2 222, . . . , PSn 226) and the loads (i.e., load1 240, load2 242, load3 244, load4 246, load5 248, . . . , loadn 250). In one embodiment, the requirements and capabilities of the power supplies 220, 222, 226 and the loads 240-250 are defined in lookup tables stored in the power rail controller 202. It should be noted that power supplies can be external to the SoC 270, such as switched-mode power supply (SMPS), low-dropout (LDO) regulator, and PMIC, or can be internal to the SoC 270, such as LDO and block-head switch.

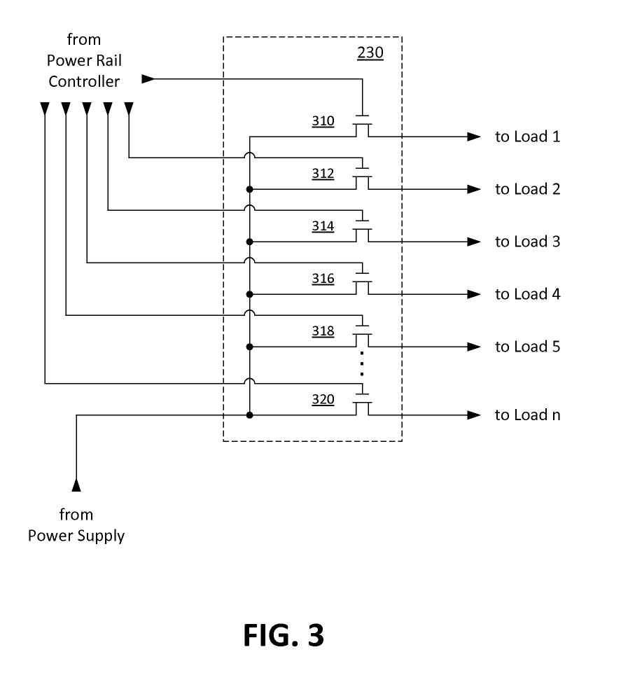

FIG. 3 is a schematic diagram of one of the power rails (e.g., power rail A 230) in accordance with one embodiment of the present invention. In the illustrated embodiment of FIG. 3, the power rail 230 includes a plurality of field-effect transistor (FET) switches 310, 312, 314, 316, 318, 320 to select the power supply (e.g., PS1 (220)) connected to the power rail 230 for each of loads 1 through n, respectively. In other embodiments, elements other than FET switches, such as mechanical or electrical switches, can be used. Further, the power rail 230 is configured to receive a plurality of control signals (e.g., n control signals) from the power rail controller 202, wherein each of the plurality of control signals is used to control one FET switch 310, 312, 314, 316, 318, or 320. Thus, when the control signal is turned on for a FET switch, the power supply is selected for the load connected to that FET switch. For example, when the control signal coming from the power rail controller 202 for FET switch 310 is turned on, the power supply is selected for Load 1. When the control signal coming from the power rail controller 202 for FET switch 312 is turned on, the power supply is selected for Load 2, and so on. In one embodiment, multiple FET switches can be turned on to allow the power supply (e.g., PS1 (220)) to connect to multiple loads. This allows splitting of the power supply. In another embodiment, a FET switch for a particular load (e.g., load 1) is turned on for multiple power rails (e.g., Power Rail A, B, . . . , n) so that multiple power supplies are connected to a particular load (i.e., multiple power supplies to one load). This allows merging of the power supplies. In yet another embodiment, multiple FET switches for multiple loads are turned on so that multiple power supplies are connected to the multiple loads.

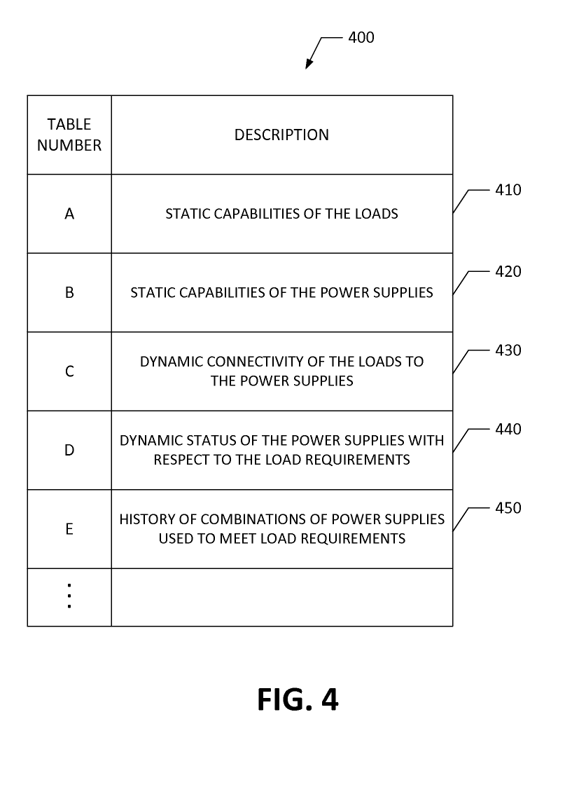

As described above, power supplies are dynamically selected and matched to the loads based on the requirements and capabilities of power supplies and loads, which are defined in lookup tables. FIG. 4 is a summary of lookup tables 400 in accordance with one embodiment of the present invention. In the illustrated embodiment of FIG. 4, the lookup tables 400 include a first table (LUT A 410) of static capabilities of the loads, a second table (LUT B 420) of static capabilities of the power supplies, a third table (LUT C 430) of dynamic connectivity of the power supplies to the loads, a fourth table (LUT D 440) of the dynamic status of the power supplies with respect to the load requirements, and a fifth table (LUT E 450) of a history of combinations of power supplies used to meet load requirements. Any number of additional lookup tables that are necessary to dynamically select and match the power supplies to the loads can be configured and used. Although the illustrated embodiments use lookup tables, any type of data structure that defines the requirements and capabilities of power supplies and loads can be used in place of the lookup tables. In some embodiments, any set of information related to the power supplies and loads can be stored and used to make a decision. In other embodiments, real-time system variables (e.g., variables that are not stored in any data structure) are used to influence load-related decisions (e.g., immediate temperature, battery voltage, etc.).

In the illustrated embodiment of FIG. 4, the first table 410 of static capabilities of the loads defines capabilities of the loads such that the rows of the table 410 define the loads and the columns of the table 410 define characteristics/capabilities of the loads including, but not limited to, the voltage range, the set switching frequency, the range of current required by the load (Iₘₐₓ), the leakage current, and the thermal slope. The second table 420 of static capabilities of the power supplies defines what power the supplies can supply such that the rows of the table 420 define the power supplies and the columns of the table 420 define different capabilities of the supplies including the maximum/minimum voltage and maximum/minimum current that the power supply can supply under various operating and system conditions (e.g., switching frequencies, temperature, external regulator component configurations, etc.). The third table 430 of the dynamic connectivity of the loads defines which load(s) are connected to which power suppl(ies) such that the rows or columns of the table 430 identify power supplies while the columns or rows of the table 430 identify loads. The data for this table 430 is dynamically changing so that it needs to be constantly updated. The fourth table 440 of the dynamic status of the power supplies with respect to the load requirements defines the current status of the power supplies as a result of connecting the loads. The rows of the table 440 define the power supplies while the columns of the table 440 define the changing state of the supplies including, but not limited to, the supply voltage, a list of acceptable switching frequencies, the current consumed by the loads connected to the power supply, and the available (remaining) current that can be consumed from the power supply. The fifth table 450 of a history of combinations of power supplies used to meet load requirements defines a past history of successful combinations of power supplies used to meet the load requirements. Additional lookup tables defining the requirements and capabilities of the power supplies and loads under various conditions and use cases can be configured and used.

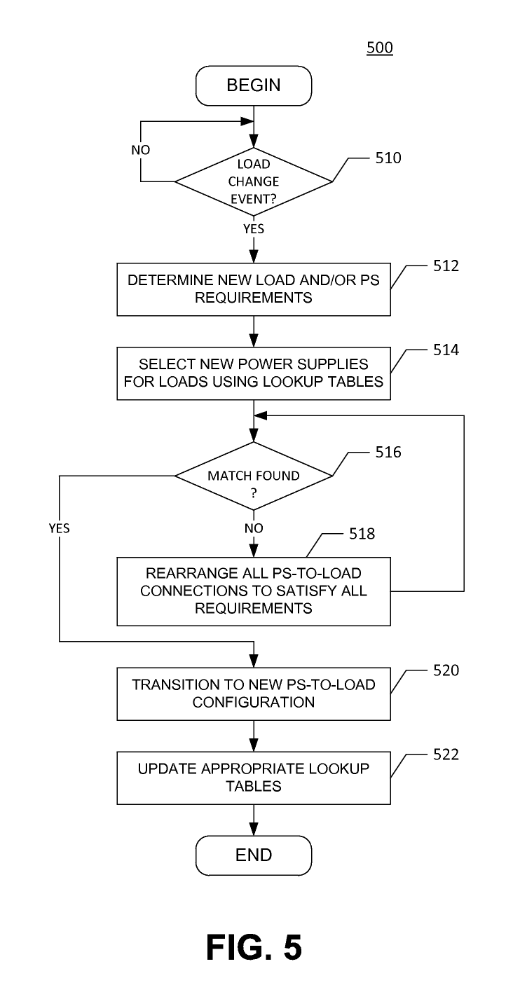

FIG. 5 is a flow diagram 500 illustrating a method for dynamically selecting power supplies for each load in accordance with one embodiment of the present invention. In the illustrated embodiment of FIG. 5, when a load change event is detected, at step 510, a new load and/or power supply requirements are determined, at step 512. The load change event includes a change in functionality, enabling/disabling of blocks, and other requirement changes that can trigger changes to a load requirement. In one example, a change in functionality includes a change in temperature that could lead to changes in voltage or current requirements. The change in functionality can also include a change in efficiency or noise requirements which triggers a change in the switching frequency of the switching power supplies. In one embodiment, a switching frequency is selected for a power supply using a list of acceptable switching frequencies. In another embodiment, a switching frequency is selected for a power supply by selecting from a good/bad list that defines switching frequencies that the load can or cannot tolerate. In other embodiments, the noise requirements define noise from shared loads that can or cannot be shared.

Once the new load/power supply requirements are determined, at step 512, power supply or supplies is/are selected for loads, at step 514, using a plurality of lookup tables identified above, for example. In one embodiment, lookup tables LUT A 410, LUT B 420, and LUT D 440 are used to select power supply or power supplies for load(s). A check is then made, at step 516, to determine if a match between power supply/supplies and load(s) is found. If no match is found, at step 516, all power supply-to-load connections are rearranged to satisfy the new load requirements, at step 518. In one embodiment, lookup table LUT E 450, which defines a plurality of combinations of the power supply-to-load connections tried in the past, can be used to select all power supply-to-load connections in the SoC 270. In another embodiment, all combinations of the power supply-to-load connections are tried to determine if a good match can be found. If a match between the power supply/supplies and load(s) is found , at step 516, a transition to a new power supply/supplies-to-load configuration is made, at step 520, and appropriate lookup table or tables are updated, at step 522. In one embodiment, dynamic lookup tables LUT C 430, which defines connectivity of the power supplies-to-load, and LUT E 450, which defines the history of combinations of power supplies used to meet load requirements, are updated to reflect the new power supply/supplies-to-load configuration.

In one embodiment, selecting new power supplies for loads includes replacing the current power supply or supplies-to-load connections. In another embodiment, selecting new power supplies for loads includes merging or splitting the power rails to change the configuration of the current power supply or supplies-to-load connections. The configurations of the power supply or supplies-to-load connections include: (1) one power supply to one load; (2) one power supply to multiple loads; (3) multiple power supplies to one load; and (4) multiple power supplies to multiple loads.

Although several embodiments of the invention are described above, many variations of the invention are possible. Further, features of the various embodiments may be combined in combinations that differ from those described above. Moreover, for clear and brief description, many descriptions of the systems and methods have been simplified. Many descriptions use terminology and structures of specific standards. However, the disclosed systems and methods are more broadly applicable.

Those of skill will appreciate that the various illustrative blocks and modules described in connection with the embodiments disclosed herein can be implemented in various forms. Some blocks and modules have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks, units, steps, components, and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Further, circuits implementing the embodiments and functional blocks and modules described herein can be realized using various transistor types, logic families, and design methodologies.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent presently preferred embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of selecting power supplies for loads, the method comprising:
determining a new load requirement for the loads when a load change event, which identifies a need to change power supply-to-load connections, is detected;
selecting at least one power supply for at least one load based on the new load requirement to generate new power supply-to-load connections; and
transitioning to the new power supply-to-load connections.

2. The method of claim 1, wherein the load change event comprises at least one of: (1) a change in functionality; (2) enabling or disabling of blocks; or (3) other requirement changes that can trigger changes to a load requirement.

3. The method of claim 2, wherein the change in functionality comprises
a change in temperature that can lead to changes in voltage or current requirements.

4. The method of claim 2, wherein the change in functionality comprises
a change in efficiency or noise requirements that triggers a change in the switching frequency of the at least one power supply.

5. The method of claim 1, further comprising
determining whether the at least one power supply selected for the at least one load meets the new load requirement.

6. The method of claim 5, further comprising
rearranging all power supply-to-load connections when the selection of the at least one power supply for the at least one load does not meet the new load requirement.

7. The method of claim 1, wherein the at least one power supply for the at least one load is selected using a plurality of lookup tables which defines requirements and capabilities of the power supplies and the loads.

8. The method of claim 7, further comprising
updating at least one lookup table of the plurality of lookup tables to reflect the new power supply-to-load connections.

9. The method of claim 1, wherein the plurality of lookup tables comprises:
a first table defining static capabilities of the loads;
a second table defining static capabilities of the power supplies;
a third table defining dynamic connectivity of the power supplies to the loads;
a fourth table defining dynamic status of the power supplies with respect to load requirements; and
a fifth table defining a history of combinations of the power supplies used to meet the load requirements.

10. A dynamic power supply selection system, comprising:
a plurality of power rails configured to connect at least one power supply to at least one load; and
a power rail controller configured to determine a load requirement for the at least one load when a load change event is detected, wherein the load change event identifies a need to change power supply-to-load connections,
the power rail controller also configured to select the at least one power supply for the at least one load based on the new load requirement and to transition the plurality of power rails to the selected power supply-to-load connections.

11. The system of claim 10, wherein each power rail of the plurality of power rails comprises:
at least one switch, each switch including a first end, a second end, and a control end,
wherein all first ends of the at least one switch connect to one of the at least one power supply,
wherein the second end connects to one of the at least one load and the control end connects to the power rail controller.

12. The system of claim 11, wherein the first ends of the at least one switch of said each power rail are tied together at a node which connects to one of the at least one power supply.

13. The system of claim 12, wherein the node of said each power rail connects to a different power supply of the at least one power supply than nodes of other power rails of the plurality of power rails.

14. The system of claim 10, wherein a number of the least one switch matches a number of the at least one power supply.

15. An apparatus for selecting power supplies for loads, the apparatus comprising:
means for determining a new load requirement for the loads when a load change event, which identifies a need to change power supply-to-load connections, is detected;
means for selecting at least one power supply for at least one load based on the new load requirement to generate new power supply-to-load connections; and
means for transitioning to the new power supply-to-load connections.

16. The apparatus of claim 15, further comprising
means for determining whether the at least one power supply selected for the at least one load meets the new load requirement.

17. The apparatus of claim 16, further comprising
means for rearranging all power supply-to-load connections when the selection of the at least one power supply for the at least one load does not meet the new load requirement.

18. The apparatus of claim 15, wherein the means for selecting comprises
means for defining requirements and capabilities of the power supplies and the loads.

19. The apparatus of claim 18, further comprising
means for updating the means for defining requirements and capabilities to reflect the new power supply-to-load connections.

20. A non-transitory storage medium storing a computer program to select power supplies for loads, the computer program comprising executable instructions that cause a computer to:
determine a new load requirement for the loads when a load change event, which identifies a need to change power supply-to-load connections, is detected;
select at least one power supply for at least one load based on the new load requirement to generate new power supply-to-load connections; and
transition to the new power supply-to-load connections.
